(19) United States
(12) Patent Application Publication
(10) Pub. No.: US 2007/0136307 A1
(43) Pub. Date: Jun. 14, 2007

(54) Network device and operation management method thereof and network communication system using the same

(75) Inventors: Han-Tzung Lin, Tu-Cheng (TW); Cheng-Hui Chen, Tu-Cheng (TW); Meng-Yueh Lin, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/518,792

(22) Filed: Sep. 11, 2006

(30) Foreign Application Priority Data
Dec. 2, 2005 (TW) 94142451

(51) Int. Cl. G06F 17/30

(52) U.S. Cl. 707/10

(57) ABSTRACT

A network device for managing middleware stored in an application server, including a receiving module for receiving a user instruction, a first detecting module for detecting whether the middleware is in use, a second detecting module for detecting whether the user instruction is preset to be executed by the middleware, and a processing module for detecting the user instruction based on an in-use status of the middleware or a detection result of the second detecting module. A network communication system incorporating at least one of the network devices is also provided. An operation protection method for a network device for preventing erroneous operation of middleware stored in an application server is further provided.

### BACKGROUND

1. Field of the Invention

The invention generally relates to network devices, and more particularly to a network device for managing external middleware.

2. General Background

With the increasing demand for greater functionality of consumer electronic products such as set-top boxes (STBs), more and more manufacturers are integrating middleware to meet this demand and provide capability to implement more functions. Being located between operation software and application software, middleware may provide a runtime and development environment to assist the user with developing and integrating a complicated application. Therefore, a network device managing the middleware may enhance the performance and use of the middleware.

The middleware is typically an item of software outside the network device, and the function performed by the middleware is preset in the process of using a network product. However, errors caused by the middleware may occur when the network performs two or more functions at the same time. This can result in a system conflict and waste of associated resources. For example, the functions of “return to the previous page” and “return to the first page” may both be preset to be performed by the middleware. The user may initiate a “return to the first page” command while the middleware is executing a “return to the previous page” command. Under normal conditions, the network product may call the middleware to execute the “return to the first page” command. However, since the middleware is currently executing the “return to the previous page” command, the “return to the first page” command may be performed by the network product itself instead. This can result in a system conflict, resource wastage, and system instability.

### SUMMARY

A network device for managing middleware stored in an application server is provided. The network device includes a receiving module for receiving a user instruction, a first detecting module for detecting whether the middleware is in use, a second detecting module for detecting whether the user instruction is preset to be executed by the middleware, and a processing module for processing the user instruction based on an in-use status of the middleware or a detection result of the second detecting module.

A network communication system incorporating at least one of the network devices is also provided. The network communication system includes a switch, an application server connected with the switch for storing middleware, a network device server connected with the switch for storing an address of the application server, and a network device including a receiving module for receiving a user instruction, a first detecting module for detecting an in-use status of the middleware, a second detecting module for detecting whether the user instruction is preset to be executed by the middleware, and a processing module for processing the user instruction based on the in-use status of the middleware or a detection result of the second detecting module.

An operation protection method for a network device for preventing erroneous operation of middleware stored in an application server is further provided. The method includes receiving a user instruction, detecting whether the middleware is in in-use, detecting whether the user instruction is preset to be executed by the middleware, and processing the user instruction by the middleware if the new instruction is preset to be executed by the middleware.

Other advantages and novel features will become more apparent from the following detailed description when taken in conjunction with the accompanying drawings, in which:

### BRIEF DESCRIPTION OF THE DRAWINGS

FIG. 1 is a schematic diagram illustrating a network communication system including three network devices in accordance with an exemplary embodiment of the invention;

FIG. 2 is a block diagram illustrating internal modules of any one of the network devices of FIG. 1;

FIG. 3 is a flowchart of an operation protection method for a network device in accordance with another exemplary embodiment of the invention; and

FIG. 4 is a flowchart of an operation protection method for a network device in accordance with a further exemplary embodiment of the invention.

### DETAILED DESCRIPTION OF THE EMBODIMENTS

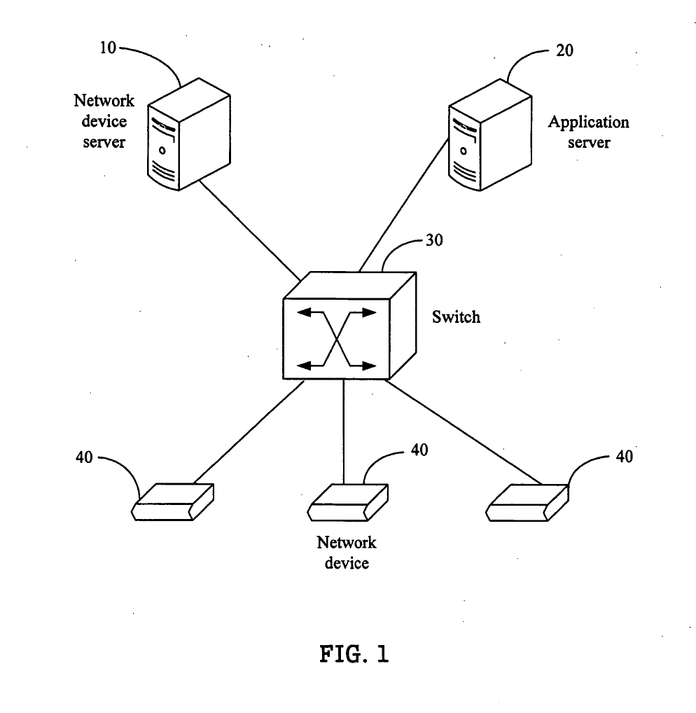

FIG. 1 is a schematic diagram illustrating a network communication system including three network devices 40 in accordance with an exemplary embodiment of the invention. The network devices 40 are connected to a network device server 10 via a switch 30. An application server 20 is also connected to the switch 30. The application server 20, whose address is stored in the network device server 10, is used for storing middleware. The network device 40 reads the address of the application server 20, and then calls and manages the middleware. In this embodiment, each network device 40 is a set top box (STB), and the network device server 10 is an STB server.

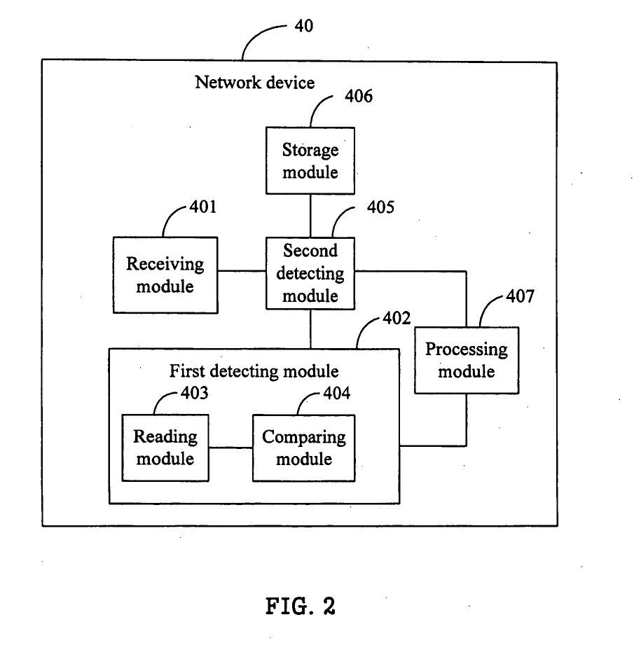

FIG. 2 is a block diagram illustrating internal modules of any one of the network devices 40. Each network device 40 includes a receiving module 401, a first detecting module 402, a second detecting module 405, a storage module 406, and a processing module 407. The receiving module 401 is used for receiving a user instruction. In this embodiment, an example user instruction such as ‘return to the first page’ may be executed by the middleware or the network device 40. The first detecting module 402 is used for detecting whether the middleware is in-use when the user instruction is received. For example, the middleware is detected to be in-use when the middleware is currently performing some other preset function such as ‘return to the previous page’. If the middleware is detected to be in-use, the user instruction is set to be executed by the network device 40 instead of by the middleware. If the middleware is detected to be not in-use, it is determined whether the user instruction is preset to be executed by the middleware. In this embodiment, the first detecting module 402 includes a reading module 403 and a comparing module 404.

In the first detecting module 402, the reading module 403 reads the address of the application server 20 stored in the network device server 10 via the switch 30. The comparing module 404 connected between the reading module 403 and the second detecting module 405 is used for comparing the address of the application server 20 with that of a page currently loaded by the network device 40 to determine the in-use status of the middleware. If the address of the application server 20 is the same as that of the page currently loaded by the network device, the middleware is currently in use. If the address of the application server 20 is different from that of the page currently loaded by the network device, the middleware is not in use. In this embodiment, the addresses of pages loaded by the network device and the application server 20 are uniform resource locator (URL) addresses.

The second detecting module 405 is connected to the receiving module 401 and the first detecting module 402 to detect whether the user instruction is preset to be executed by the middleware. That is, if the middleware is in use at the time the user instruction is received by the receiving module 401, the second detecting module 405 detects whether the user instruction is in a function chart of the middleware. In this embodiment, the function chart of the middleware is used for storing a list of functions preset to be executed by the middleware, and is stored in the storage module 406 connected with the second detecting module 405.

The processing module 407 is connected between the first detecting module 402 and the second detecting module 405 to execute the user instruction based on the status of the middleware or a detection result of the second detecting module 405. In other words, when the middleware is in use or when the user instruction is not preset to be executed by the middleware, the processing module 407 processes the user instruction.

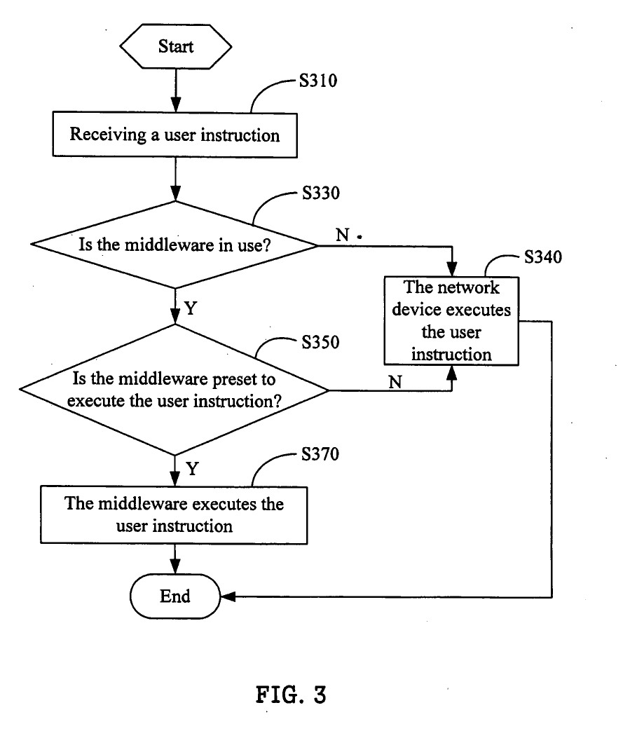

FIG. 3 is a flowchart of an operation management method for a network device 40 in accordance with another exemplary embodiment of the invention. In step S310, the receiving module 401 receives a user instruction. In step S330, the first detecting module 402 detects whether the middleware is in use. If the middleware is in use, then in step S340, the user instruction is executed by the network device 40 instead of the middleware, and the corresponding function is thereby performed. If the middleware is not in use, the process proceeds to step S350, where the second detecting module 405 detects whether the middleware is preset to execute the user instruction. That is, the second detecting module 405 detects whether the user instruction is in the function chart of the middleware. If the user instruction is not preset to be processed by the middleware (i.e. the user instruction is not in the function chart of the middleware), the process proceeds to step S340, where the network device 40 executes the user instruction so that the corresponding function is performed. If the user instruction is preset to be executed by the middleware (i.e. the user instruction is in the function chart of the middleware), the process proceeds to step S370, where the middleware executes the user instruction so that the corresponding function is performed.

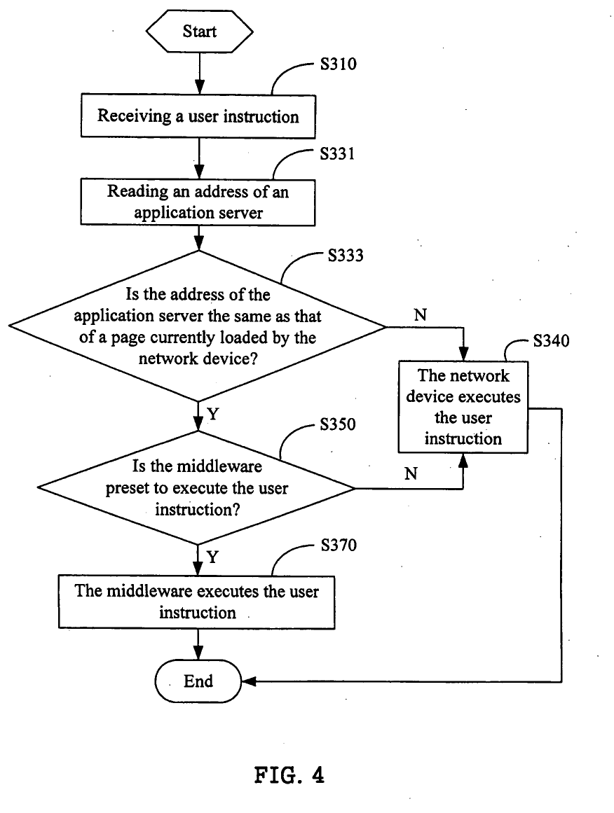

FIG. 4 is a flowchart of an operation protection method for a network device in accordance with a further exemplary embodiment of the invention. The flowchart of FIG. 4 is similar to that of FIG. 3, but shows more detailed steps for implementing step S330 of FIG. 4. In step S331, the reading module 403 reads the address of the application server 20, which is stored in the network device server 10. In step S333, the comparing module 404 compares the address of the application server 20 with that of the page currently loaded by the network device 40 to detect whether the middleware is in use. If the address of the application server 20 is the same as that of the page currently loaded by the network device, the middleware is in use and the process proceeds to step S340. If the address of the application server 20 is different from that of the page currently loaded by the network device, the middleware is not in use and the process proceeds to step S350.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

We claim:

1. A network device for managing middleware stored in an application server, comprising:
a receiving module for receiving a user instruction;
a first detecting module for detecting whether the middleware is in use;
a second detecting module for detecting whether the user instruction is preset to be executed by the middleware; and
a processing module for processing the user instruction based on an in-use status of the middleware or a detection result of the second detecting module.

2. The network device according to claim 1, wherein the first detecting module comprises:
a reading module for reading an address of the application server; and
a comparing module connected between the reading module and the second detecting module for comparing the address of the application server and that of a page currently loaded by the network device, in order to determine the in-use status of the middleware.

3. The network device according to claim 2, wherein the address of the page currently loaded by the network device and the address of the application server are uniform resource locator addresses.

4. The network device according to claim 1, further comprising a storage module connected with the second detecting module, for storing a function chart of the middleware, the function chart being for storing functions preset to be processed by the middleware.

5. The network device according to claim 4, wherein the second detecting module is used for detecting whether the user instruction is listed in the function chart of the middleware.

6. The network device according to claim 1, wherein the first detecting module detects the in-use status of the middleware when the user instruction is received.

7. The network device according to claim 6, wherein the second detecting module detects whether the user instruction is preset to be executed by the middleware if the middleware is not in use.

8. A network communication system, comprising:
a switch;
an application server connecting with the switch for storing middleware; and
a network device, comprising:
a receiving module for receiving a user instruction;
a first detecting module for detecting an in-use status of the middleware;
a second detecting module for detecting whether the user instruction is preset to be executed by the middleware; and
a processing module for processing the user instruction based on the in-use status of the middleware or a detection result of the second detecting module.

9. The network communication system according to claim 8, further comprising a network device server connected with the switch for storing the address of the application server.

10. The network communication system according to claim 9, wherein the first detecting module comprises:
a reading module for reading the address of the application server; and
a comparing module connected between the reading module and the second detecting module for comparing the address of the application server and that of a page currently loaded by the network device, in order to determine the in-use status of the middleware.

11. The network communication system according to claim 10, wherein the address of the page currently loaded by the network device and the address of the application server are uniform resource locator addresses.

12. The network communication system according to claim 8, further comprising a storage module connected with the second detecting module, for storing a function chart of the middleware, the function chart being for storing functions preset to be processed by the middleware.

13. The network communication system according to claim 12, wherein the second detecting module is used for detecting whether the user instruction is listed in the function chart of the middleware.

14. The network communication system according to claim 8, wherein detecting the in-use status of the middleware is performed when the user instruction is received.

15. The network communication system according to claim 8, wherein the second detecting module detects whether the user instruction is preset to be executed by the middleware if the middleware is not in use.

16. An operation management method for a network device for preventing erroneous operation of middleware, the method comprising:
receiving a user instruction;
detecting whether the middleware is in use;
detecting whether the user instruction is preset to be executed by the middleware if the middleware is in use; and
processing the user instruction by the middleware if the user instruction is preset to be executed by the middleware.

17. The operation management method according to claim 16, wherein detecting whether the middleware is in use comprises:
reading an address of an application server; and
comparing the address of the application server and that of a page currently loaded by the network device.

18. The operation management method according to claim 17, wherein the address of the page currently loaded by the network device and the address of the application server are uniform resource locator addresses.

19. The operation management method according to claim 16, further comprising the step of processing the user instruction by the network device, if the middleware is not in use.

20. The operation management method according to claim 16, further comprising the step of processing the user instruction by the network device if the user instruction is not preset to be executed by the middleware.
